(19) United States
(12) Patent Application Publication
(10) Pub. No.: US 2026/0175860 A1
(43) Pub. Date: Jun. 25, 2026

(54) INFORMATION PROCESSING DEVICE

(71) Applicant: TOYOTA JIDOSHA KABUSHIKI KAISHA, Toyota-shi (JP)

(72) Inventors: Naoki UENOYAMA, Kasugai-shi (JP); Koki MORI, Inuyama-shi (JP); Shinichi YAMAMOTO, Toyota-shi (JP); Yuki NAKAGAWA, Toyota-shi (JP)

(73) Assignee: TOYOTA JIDOSHA KABUSHIKI KAISHA, Toyota-shi (JP)

(21) Appl. No.: 19/392,715

(22) Filed: Nov. 18, 2025

(30) Foreign Application Priority Data
Dec. 20, 2024 (JP) 2024-225163

(51) Int. Cl. B60W 50/14; G06N 20/00

(52) U.S. Cl. CPC B60W 50/14; G06N 20/00; B60W 2050/143; B60W 2050/146; B60W 2556/10; B60W 2556/45

(57) ABSTRACT

The information processing device includes a communication unit that communicates with the vehicle, a storage unit that stores history information in which past driving situations in the vehicle or other vehicle are associated with work that has not been performed by the user of each vehicle at a predetermined timing, and a control unit that receives information on the current driving situation from the vehicle at a predetermined timing and transmits information for presenting an assumed work corresponding to the current driving situation to the user of the vehicle to the vehicle.

### CROSS-REFERENCE TO RELATED APPLICATION

This application claims priority to Japanese Patent Application No. 2024-225163 filed on Dec. 20, 2024. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

There are known techniques of improving user experience by assisting a user of a vehicle. As one of such techniques, a technique of presenting the content of work to a user of a vehicle has been proposed. For example, Japanese Unexamined Patent Application Publication No. 2005-240349 (JP 2005-240349 A) discloses a technique in which, when an in-vehicle notification device detects a forgotten operation, a forgotten operation notification signal is transmitted to a center device, and the center device transmits the forgotten operation notification signal to a user device registered in advance.

### SUMMARY

In a technique of presenting the content of work to a user of a vehicle, there is room for more accurately determining the content of work to be presented.

In a technique of presenting the content of work to a user of a vehicle, the present disclosure allows more accurately determining the content of work to be presented.

An aspect of the present disclosure provides an information processing device including:
a communication unit that communicates with a vehicle;
a storage unit that stores history information in which a past driving situation of the vehicle or another vehicle and work that was not carried out by a user of each vehicle at a predetermined timing are correlated; and
a control unit that receives information on a first driving situation from the vehicle at the predetermined timing and that sends information for presenting first work corresponding to the first driving situation toward the user of the vehicle to the vehicle.

According to an aspect of the present disclosure, it is possible to more accurately determine the content of work to be presented to a user of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a schematic configuration of an information-providing system; and

FIG. 2 is a flowchart illustrating an operation of the information processing device.

### DETAILED DESCRIPTION OF EMBODIMENTS

Hereinafter, an embodiment of the present disclosure will be described.

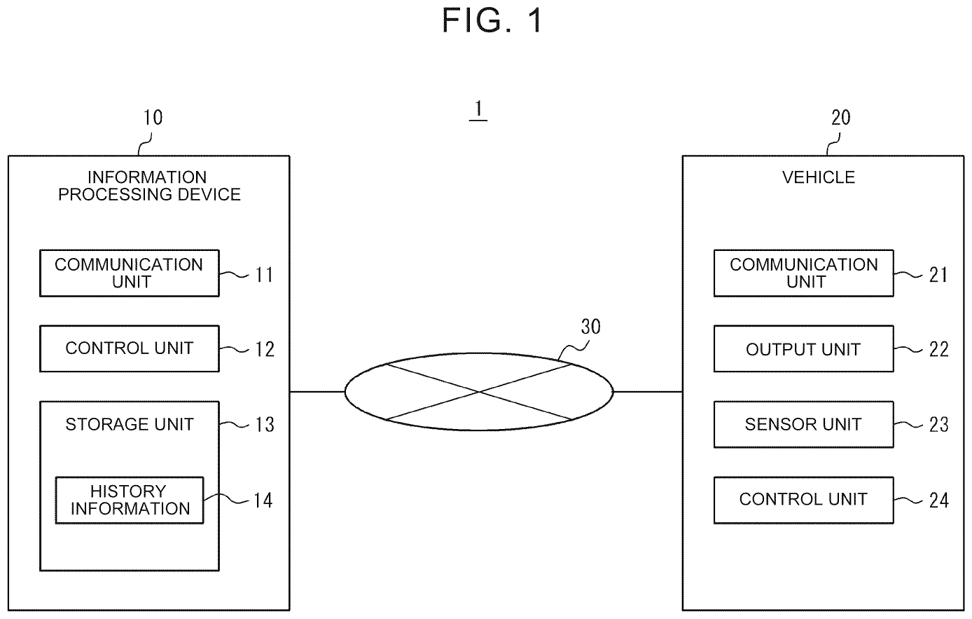

With reference to FIG. 1, an outline of a system 1 according to an embodiment of the present disclosure will be described. The information providing system 1 includes one or more information processing devices 10 and a vehicle 20. The information processing device 10 and the vehicle 20 are connected via a network 30 including, for example, the Internet and a mobile communication network so as to be capable of information communication.

The information processing device 10 belongs to, for example, a cloud computing system or other computing system, and is a computer such as a server apparatus that implements various functions. The information processing device 10 may be configured by two or more computers that are connected so as to be capable of information communication and operate in cooperation with each other.

The vehicle 20 is, for example, an automobile or a commercial vehicle. Vehicles are BEV (Battery Electric Vehicle), HEV (Hybrid Electric Vehicle). Or, the motor vehicle may be, but is not limited to, PHEV (Plug-in Hybrid Electric Vehicle), or FCEV (Fuel Cell Electric Vehicle).

The information processing device 10 according to the present embodiment includes a communication unit 11 that communicates with the vehicle 20, a storage unit 13, and a control unit 12. The storage unit 13 stores history information 14 in which past driving conditions in the vehicle 20 or the other vehicle 20 are associated with work (hereinafter, referred to as non-execution work) that has not been performed by the user of each vehicle 20 at a predetermined timing. The control unit 12 receives information on the first driving state (hereinafter, referred to as the current driving state) from the vehicle 20 at a predetermined timing, and sends information for presenting the first work (hereinafter, referred to as the assumed work) corresponding to the current driving state to the user of the vehicle 20 to the vehicle 20.

The history information 14 includes information associating the past driving status of the vehicle 20 with the non-execution work for each user of the vehicle 20. Based on the history information 14, the information processing device 10 can determine whether or not there is an unexecuted operation in the past driving situation corresponding to the current driving situation of the user, that is, an assumed operation in which the user is likely to be negligent. The current driving situation and the past driving situation are driving situations, and include, for example, a time zone, an external situation (weather, traffic jam information, and the like), an in-vehicle situation (the number of passengers, the number of children, and the like). The current driving situation and the past driving situation further include a driving situation (such as a departure point, a destination point, a traveling distance, a traveling time, and the number of sudden start and sudden stop). The non-execution work or the assumed work is, for example, forgetting to close a window or a door, forgetting to turn off a light, forgetting to operate a shift lever, forgetting to lock a door, forgetting to place a vehicle key or a package, or the like. In addition, the information processing device 10 determines the presence or absence of the assumed work by using not only the history information 14 of the own vehicle 20 which the user himself/herself drives and accumulates but also the history information 14 of the other vehicle 20 which the other user drives and accumulates. Thus, for example, even when the driving situation is different from the normal driving situation or a new vehicle in which the history information 14 is not sufficiently accumulated, it is possible to determine whether or not there is an assumed work corresponding to the driving situation of the user. Therefore, it is possible to more accurately determine the work content to be presented to the user of the vehicle 20.

Each configuration of the information processing device 10, that is, the communication unit 11, the control unit 12, and the storage unit 13 will be described.

The communication unit 11 includes one or more communication interfaces connected to the network 30. The communication interfaces correspond to, for example, a mobile communication standard, a wired LAN (Local Area Network) standard, or a radio LAN standard, but are not limited thereto, and may correspond to any communication standard. In the present embodiment, the information processing device 10 communicates with the vehicle 20 via the communication unit 11 and the network 30.

The control unit 12 may be one or more processors, one or more programmable circuits, one or more dedicated circuits, or a combination thereof. The processor may be, for example, but not limited to, a general-purpose processor such as CPU (Central Processing Unit), GPU (Graphics Processing Unit), or a special-purpose processor specialized for a particular process. The programmable circuitry is, for example, but not limited to, FPGA (Field-Programmable Gate Array). The dedicated circuitry is, for example, but not limited to, ASIC (Application Specific Integrated Circuit). The control unit 12 controls the operation of the information processing device 10 as a whole.

The storage unit 13 includes one or more memories. Each memory included in the storage unit 13 may function as, for example, a main storage device, an auxiliary storage device, or a cache memory. The storage unit 13 stores arbitrary information used for the operation of the information processing device 10. For example, the storage unit 13 may store a system program, an application program, a database, map information, and the like. The information stored in the storage unit 13 may be updatable by, for example, information acquired from the network 30 via the communication unit 11. The storage unit 13 stores history information 14.

Next, each configuration of the vehicle 20 will be described in detail. As illustrated in FIG. 1, the vehicle 20 includes a communication unit 21, an output unit 22, a sensor unit 23, and a control unit 24.

The communication unit 21 includes one or more communication interfaces connected to the network 30. The communication interfaces correspond to mobile communication standards such as 4G (4th Generation), 5G (5th Generation), for example, but are not limited thereto. In the present embodiment, the vehicle 20 communicates with the information processing device 10 via the communication unit 21 and the network 30.

The output unit 22 includes an interface for connecting one or more output devices or one or more output devices for outputting information. The output device is, for example, a display, a speaker, or the like.

The sensor unit 23 is an interface for connecting one or more sensors or one or more sensors for detecting information regarding the operation of the vehicle 20 or the surrounding environment. The sensors include a speed sensor, an acceleration sensor, a seating sensor, an exterior camera as an image sensor, an interior camera, and the like. The sensor unit 23 sends the information detected by the various sensors to the control unit 24 as the information of the host vehicle 20.

The control unit 24 may be one or more processors, one or more programmable circuits, one or more dedicated circuits, or a combination thereof. The processor may be, for example, but not limited to, a general-purpose processor such as CPU (Central Processing Unit), GPU (Graphics Processing Unit), or a special-purpose processor specialized for a particular process. The programmable circuitry is, for example, but not limited to, FPGA (Field-Programmable Gate Array). The dedicated circuitry is, for example, but not limited to, ASIC (Application Specific Integrated Circuit). The control unit 24 controls the overall operation of the vehicle 20.

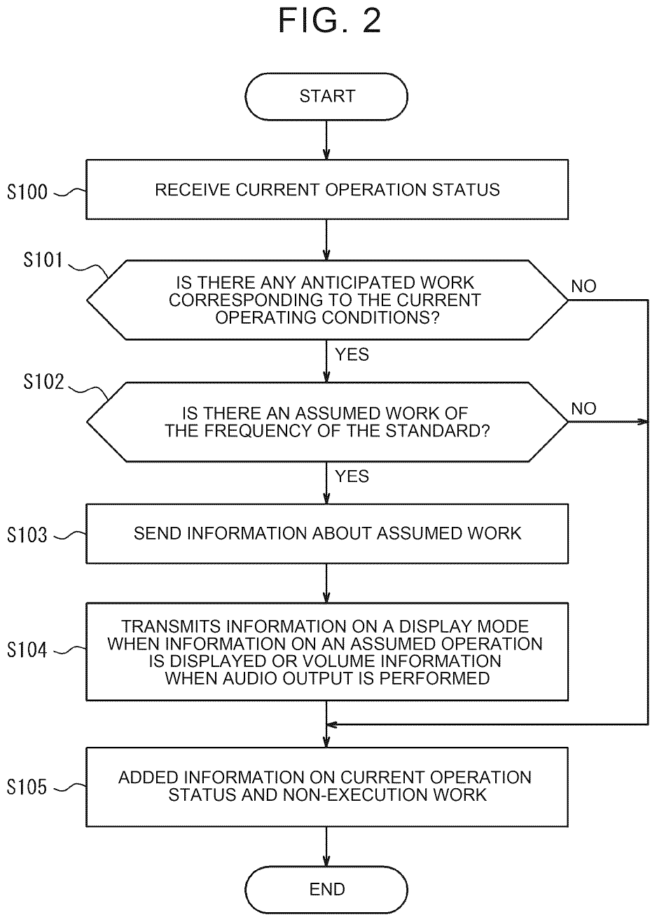

An operation of the information processing device 10 according to the present embodiment will be described with reference to FIG. 2.
S100: The control unit 12 of the information processing device 10 receives information on the present driving state from the vehicles 20 at predetermined timings via the communication unit 11. The timing at which the control unit 12 receives the information may be, for example, a timing at which the engine of the vehicle 20 is stopped. Alternatively, the timing at which the control unit 12 receives the information may be a timing at which a change in arbitrary information included in the current driving situation is detected, or a timing at which the vehicle 20 receives a request for transmission of the information from the information processing device 10.
S101: The control unit 12 determines whether or not there is an assumed operation corresponding to the present driving state in the history information 14. For example, the control unit 12 extracts, from the history information 14, a past driving situation in which at least a part of the current driving situation matches the current driving situation, and determines whether or not there is an assumed work corresponding to the extracted past driving situation, based on whether or not there is any assumed work. The control unit 12 uses the history information 14 of the host vehicle 20 to determine whether or not there is an assumed work. In a case where there is no information matching the current driving situation in the history information 14 of the host vehicle 20, for example, in a case of a user of a new vehicle or the like, the presence or absence of an assumed work is determined using the history information 14 of the host vehicle 20 and the other vehicle 20. When the control unit 12 determines that there is an assumed operation corresponding to the present driving state in the history information 14, S102 is executed. On the other hand, when the control unit 12 determines that there is no assumed operation corresponding to the present driving state in the history information 14, S105 is executed.
S102: The control unit 12 determines whether or not the frequency of the assumed operation is the frequency of the reference. The frequency of the assumed work is the frequency of the corresponding non-execution work, and is obtained by the control unit 12, for example, as a ratio of the number of times that the non-execution work has occurred to the number of times that a certain operation state has occurred. The frequency of the reference is, for example, an arbitrary value of 20 to 50%, or an average value of the frequency of the non-execution work included in the history information 14. The control unit 12 may include information on the obtained frequency in the history information 14. The control unit 12 executes S103 when it is determined that the frequency of the assumed operation is the frequency of the reference. On the other hand, when the control unit 12 determines that the frequency of the assumed operation is not the frequency of the reference, S105 is executed.
S103: The control unit 12 sends, to the vehicle 20 via the communication unit 11, information for presenting an assumed task corresponding to the present driving state to the user of the vehicle 20. The control unit 24 of the vehicle 20 may display the information of the assumed work received via the communication unit 21 on the output unit 22.

The control unit 12 may further send information for presenting the assumed work to the communication terminal. In this case, the storage unit 13 further stores information of the communication terminal of the user. The communication terminal includes any communicable device such as a smartphone, a personal computer, and a smartwatch. By presenting the information of the assumed work to the output unit 22 or the communication terminal of the vehicle 20, the probability that the user performs the assumed work is improved. Further, by presenting the information of the assumed work to the communication terminal, the user can confirm the information of the assumed work even after getting off.
S104: The control unit 12 may further send, to the vehicle 20, information on a display mode when displaying the information on the assumed operation toward the user or volume information when outputting sound. The information on the display mode includes, for example, information on the brightness and the display time of the screen on which the information on the assumed work is displayed. The volume information is information obtained by digitizing the output volume from 0 to 100%. The control unit 12 sends, for example, information for changing a display mode when displaying information on the assumed work or a volume when outputting sound based on the frequency of the assumed work. For example, in a case where the frequency of the assumed work is a value of 50 to 60% or more, in order to increase the degree of attention of the user, information such as increasing the brightness of the screen on which the information of the assumed work is displayed, increasing the display time, or increasing the volume of the audio output is sent. Further, when the frequency is a value of less than 20% to 40%, information such as lowering the luminance of the screen on which the information of the assumed work is displayed, shortening the display time, or reducing the volume of the audio output is sent. Note that the control unit 12 may further send information on a display mode when the information on the assumed work is displayed toward the user or volume information when the voice is output to the communication terminal.
S105: The control unit 12 receives information on the present driving state and the non-execution operation from the vehicles 20 and adds the information to the history information 14. As a result, information such as the frequency at which each operation included in the history information 14 was not performed is calculated again and updated.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 10 may be distributed among a plurality of computers capable of communicating with each other. Further, for example, an embodiment in which some or all of the components of the information processing device 10 are provided in a navigation device mounted on the vehicle 20 is also possible.

In addition, in the above-described embodiment, the storage unit 13 may store a machine learning model in which information on a past driving situation is trained as a feature amount and information on an unexecuted work is used as a correct answer label. In such cases, in S101, the control unit 12 may receive the information on the current driving state from the vehicle 20 at a predetermined timing, input the information on the current driving state into the machine learning model, and determine an assumed operation using the machine learning model. Thus, even when there is no information in the history information 14 that matches the current driving state, the control unit 12 can determine the assumed operation.

Further, in the above-described embodiment, the operation of the vehicle 20 may be changed depending on whether or not the user performs the assumed work at a predetermined timing. For example, when the control unit 24 of the vehicle 20 determines that the user is performing the assumed work at a predetermined timing, the information on the assumed work may not be presented to the user. Accordingly, it is possible to suppress the control unit 24 unnecessarily presenting to the user.

Further, in the above-described embodiment, the operation of the information processing device 10 may be changed depending on whether or not the user performs the assumed work at a predetermined timing. For example, the control unit 24 of the vehicle 20 sends the determination result of whether or not the user is performing the assumed work to the information processing device 10 via the communication unit 21. The control unit 12 of the information processing device 10 does not need to transmit information on the assumed work to be presented to the user to the vehicle 20 and the communication terminal of the user when the user performs the assumed work. Accordingly, it is possible to suppress the control unit 12 making unnecessary presentation to the user.

What is claimed is:

1. An information processing device comprising:
a communication unit that communicates with a vehicle;
a storage unit that stores history information in which a past driving situation of the vehicle or another vehicle and work that was not carried out by a user of each vehicle at a predetermined timing are correlated, and a machine learning model trained using information on the past driving situation as a characteristic quantity and using information on the work that was not carried out by the user at the predetermined timing as a correct answer label; and
a control unit that receives information on a first driving situation from the vehicle at the predetermined timing and that sends information for presenting first work toward the user of the vehicle to the vehicle, the first work being determined by inputting the information on the first driving situation to the machine learning model.

2. An information processing device comprising:
a communication unit that communicates with a vehicle;
a storage unit that stores history information in which a past driving situation of the vehicle or another vehicle and work that was not carried out by a user of each vehicle at a predetermined timing are correlated; and
a control unit that receives information on a first driving situation from the vehicle at the predetermined timing and that sends information for presenting first work corresponding to the first driving situation toward the user of the vehicle to the vehicle.

3. The information processing device according to claim 2, wherein:
the storage unit further stores information on a communication terminal of the user; and
the control unit further sends information on the first work to the communication terminal.

4. The information processing device according to claim 2, wherein:
the history information further includes information on a frequency at which each work was not carried out; and
the control unit sends out information on the first work on condition that the frequency of the first work is a reference frequency.

5. The information processing device according to claim 4, wherein the control unit further sends, to the vehicle, information on a display mode when displaying the information on the first work toward the user or information on a volume when audibly outputting the information on the first work toward the user.
